(19) United States
(12) Patent Application Publication
(10) Pub. No.: US 2024/0269745 A1
(43) Pub. Date: Aug. 15, 2024

(54) METHODS FOR IN SITU FORMATION OF DISPERSOIDS STRENGTHENED REFRACTORY ALLOY IN 3D PRINTING AND ADDITIVE MANUFACTURING

(71) Applicant: Addman Intermediate Holdings, LLC, Fort Myers, FL (US)

(72) Inventor: Youping Gao, Thousand Oaks, CA (US)

(21) Appl. No.: 18/438,949

(22) Filed: Feb. 12, 2024

Related U.S. Application Data
(63) Continuation-in-part of application No. 18/070,869, filed on Nov. 29, 2022.
(63) Continuation-in-part of application No. 17/024,635, filed on Sep. 17, 2020, now Pat. No. 11,677,254.

(51) Int. Cl. B22F 10/28; B22F 1/14; B22F 10/50; B33Y 10/00; B33Y 80/00

(52) U.S. Cl. CPC B22F 10/28; B22F 1/14; B22F 10/50; B22F 2201/02; B22F 2201/03; B22F 2201/10; B22F 2301/20; B22F 2304/10; B33Y 10/00; B33Y 80/00

(57) ABSTRACT

Methods of fabricating objects using additive manufacturing are provided using pretreated powders. In a first aspect, the methods create in situ dispersoids within the object to increase the oxygen content to between 500 ppm and 3000 ppm or to increase the nitrogen content to between 250 ppm and 1500 ppm. The pretreated powders are then formed into layers in an environmentally controlled chamber of an additive manufacturing machine. The quantity of refractory alloy powder is partially pretreated by exposure to the atmosphere for a selected period of time or in an inert atmosphere having oxygen and/or nitrogen introduced thereinto. The partially pretreated quantity of powder is then further pretreated in an inert atmosphere controlled chamber to raise the oxygen and/or nitrogen level to between about 250 ppm and 1000 ppm for nitrogen and between about 500 ppm and 2000 ppm for oxygen. The layers of pretreated powder are then exposed to a transient moving energy source or stationary energy source for melting and solidifying the layers; and creating in situ dispersoids in the layers. In a second aspect, carbon dioxide is introduced into an inert atmosphere controlled chamber having hafnium powder therein for creating hafnium carbide dispersoids throughout the object.

### CROSS-REFERENCE TO RELATED APPLICATION

This application is a continuation-in-part application of U.S. patent application Ser. No. 18/070,869, filed on Nov. 29, 2022 which, in turn, is a continuation-in-part of U.S. patent application Ser. No. 17/024,635, filed Sep. 17, 2020 which is now U.S. patent Ser. No. 11/519,063, the disclosures of which are hereby incorporated by reference including the drawing.

### PRIOR ART

In general, refractory alloys are mostly solid solution strengthened (substitutional strengthened) and are very sensitive to contamination from interstitial elements such as oxygen, nitrogen and carbon, to name a few. The most popular refractory alloy in the aerospace industry is Niobium Alloy C103 (Nb-10Hf-1Ti). Other refractory alloys include but are not limited to Niobium (Nb), Rhenium (Re), Tantalum (Ta), Molybdenum (Mo) and Tungsten (W) to name a few. When concentrations of interstitial elements are above certain limits, such as O₂≥350 ppm and/or N₂≥100 ppm, the refractory alloys properties degrade significantly. For example, refractory alloys may experience embrittlement and/or loss of ductility, which will significantly degrade the material.

The main reason for the degradation of refractory alloys in the face of contamination is due to the following: A) The interstitial elements did not form stable oxides and/or nitrides; B) The interstitial elements are not in the size range where cohesive strengthening can be provided; and/or C) The interstitial elements are not distributed evenly but laced in the grain boundary, which weakens the overall materials properties. Accordingly, refractory alloys have very tight, not to exceed, interstitial contents tolerances in the wrought form.

Solid solution strengthened refractory alloys can be, in theory, strengthened by dispersoids. However, in reality, it has never been achieved because of the difficulty to distribute proper dispersoids in the melting process, the poor low-temperature workability of refractory alloys, which limit its ability to homogenize, and the high temperature oxidation tendency. These qualities all make the process of strengthening refractory alloys using dispersoids impossible to achieve.

Accordingly, current practice in the art of additive manufacturing is to maintain oxygen and contaminants within the sintering chamber at or below certain levels. For example, EP3368312 teaches that a gas management system maintains gaseous oxygen within the interior of the enclosure at or below a limiting oxygen concentration equivalent to the atmospheric level. This is thought to be important for many reasons but mostly to prevent contamination. References like U.S. Patent Publication 2018/0126650 point out that oxygen and or nitrogen will potentially contaminate the additive manufacturing process.

Additive manufacturing is a rapidly growing industry and there is a need to be able to create stronger materials and alloys that can be used with the additive manufacturing process. To this end, there is a great need to figure out methods and processes to create stronger parts using the additive manufacturing process. Stronger parts typically result from stronger alloys and thus, there is a need for stronger alloys, particularly stronger refractory alloys, for use with the additive manufacturing process.

Refractory metals are a group of metallic elements that have extraordinary resistance to heat and wear. They have high melting points nearly double that of superalloys but ironically, they also have poor oxidation resistance except for a few extremely expensive elements such as iridium in the extended refractory family. Furthermore, their intrinsic characteristics of being hard and resistant to heat also makes them difficult to fabricate. Currently, there is no ideal alloy that can be deployed at elevated temperatures of about 2000°-3300° F. with strength capability, oxidation resistance and with reasonable fabrication abilities, and is affordable as structural materials in industrial scale. The Niobium Alloy C103 is the closest material to the “ideal high temperature alloy” and is an indispensable structural material for elevated temperature applications. Niobium C103 Alloys are predominantly being used in uncooled rocket engine combustion chambers, thrusters, and uncooled nozzle extension sections. A space shuttle's reaction control system in the nose of the orbiter experience˜M25 speed upon reentry therefore are amenable to using Niobium Alloy C103.

Niobium alloy C103 was developed in the 1960s for uncooled structures at elevated temperatures typically 2000° F. to 3000° F. for space propulsion applications. It is relative light in density comparing to other refractory metals. It is the only tri elemental refractory alloy being produced without interruption in industrial scale production which demonstrates its industrial value as high temperature structural material even though it has relatively low strength. However, through additive manufacturing, particularly Laser Powder Bed Fusion (LPBF), not only the shaping of the alloys has expanded an extraordinary degree, while also increasing its strength, creep resistance, and eliminated the grain boundary oxidation mode while reducing manufacturing cost by an order of magnitude by improving the materials buy to fly ratio. The gain in strength, creep resistance, and oxidation resistance, particularly in the elevated temperature range is due to the formation of well dispersed oxides in the alloy and grain boundary engineering without modifying the alloys composition which doesn't affect the existing supply chain. The Oxides Dispersion Strengthening (ODS) effectiveness along with creating complex grain boundaries through LPBF in this alloy are so remarkable that these nearly doubled the alloy's strength in the elevated temperature range while maintaining composition compliance. The increased materials properties also pushed the materials application to 3300° F. range which greatly improved rocket engines performance and reliability.

The following Scanning Electron Microscope (SEM) vividly demonstrates the formation by LPBF of the Hafnium Oxide (HfO) well dispersed in the grain boundary and within the grains with larger grain boundary oxides and finer oxides in the grain. The Hafnium Oxide is the amongst the most stable oxides in the world. The ability of naturally formation of such effective strengthening mechanism that is so ideally distributed is well beyond anyone's dream in materials processing.

### BACKGROUND OF THE INVENTION

The present invention generally relates to processes for additive manufacturing for producing dispersoids strengthened materials (e.g., oxides and/or nitrides enriched powders and/or processed additives under enriched oxygen and/or nitrogen), and additively manufacturing materials and objects produced by these processes and materials.

### SUMMARY OF THE INVENTION

The present invention provides improved methods of manufacturing powders for use in additive manufacturing and improved methods for manufacturing or fabricating objects using additive manufacturing. In preferred embodiments, the methods of fabricating an object using additive manufacturing comprise selecting a refractory alloy powder from the group consisting of Niobium, Rhenium, Tantalum, Molybdenum and Tungsten alloy powders.

In one embodiment, once a powder is selected, the powder is pretreated to increase the oxygen content to between 500 ppm and 3000 ppm or to increase the nitrogen content to between 250 ppm and 1500 ppm or both. Increasing the oxygen and/or nitrogen is achieved by surface oxidation, partially in the ambient and partially in a controlled inert atmosphere having controlled amounts of oxygen and/or nitrogen injected thereinto.

After the powder is pretreated, a layer of the refractory alloy powder is created in an environmentally controlled inert gas chamber of an additive manufacturing machine and having a suitable quantity of oxygen and/or nitrogen introduced into the chamber by any suitable means. The environment is controlled in the chamber to be between 500 ppm and 2000 ppm oxygen. Then the layer is exposed to a transient moving or stationary energy source for melting and solidifying the layer. Finally, dispersoids are formed in situ in the layer with diameters between 1 micron and 10 microns.

In preferred embodiments, the environmentally controlled chamber may also be adjusted to be between 250 ppm and 1000 ppm nitrogen.

depositing of powder and the melting and solidifying of the layers is repeated until the object is created.

In another aspect hereof there is provided a method of introducing into the object a product hafnium-based oxides and carbides.

For a more complete understanding of the present invention, reference is made to the following detailed description and accompanying drawing.

### BRIEF DESCRIPTION OF THE DRAWINGS

FIG. 1 illustrates an extremely close up optical image of the microstructure of annealed Nb C103 (wrought materials).

FIG. 2 illustrates an extremely close up optical image of the microstructure of Nb C103 after heating at 2900° F. for two hours.

FIG. 3 illustrates an extremely close up optical image of the microstructure of annealed Nb C103 that has been printed using the additive manufacturing techniques taught herein.

FIG. 4 illustrates an extremely close up optical image of the microstructure of Nb C103 that has been printed using the additive manufacturing techniques taught herein after heating at 2,900° F. for two hours.

FIG. 5 is a photograph of the grain composition of an HfO dispersoid where the white particles are delineated along the grain boundaries and spread across the grain material.

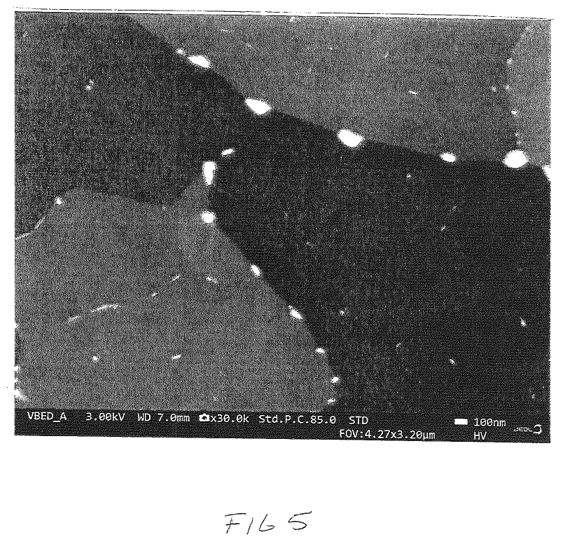

### DETAILED DESCRIPTION OF THE INVENTION

Despite the fact that it is known that the inclusion of interstitial elements causes contamination in refractory alloys, contrary thereto, it has now been found that if done correctly, elevated levels of contamination from interstitial elements such as oxygen, nitrogen and carbon introduced into the refractory alloy powder can actually provide a benefit in the additive manufacturing process.

By intentionally adding oxygen and/or nitrogen above the typical specified limit, for example double the industry standard oxygen content, the contaminants create oxides and/or nitrides dispersoids that can be distributed evenly throughout the body of additively produced objects.

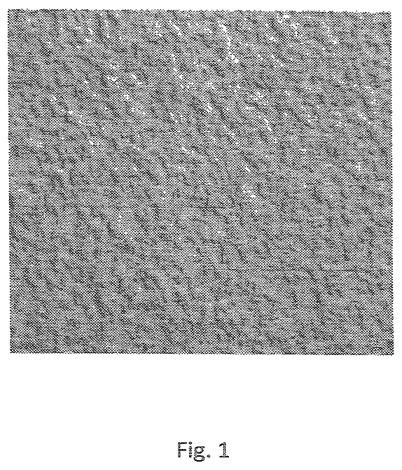

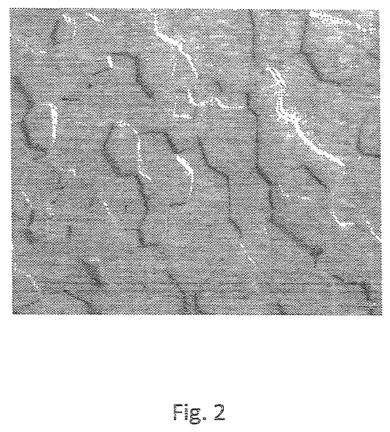

The creation and addition of homogenous dispersoids creates a stable microstructure at elevated temperatures. FIG. 1 illustrates an extremely close up optical image of the microstructure of annealed Nb C103 (wrought material). FIG. 2. illustrates an extremely close up optical image of the microstructure of Nb C103 after heating at 2900º F for two hours. As may be seen in FIG. 2, the exposure to heat creates significant grain coarsening, grain growth, in the wrought material.

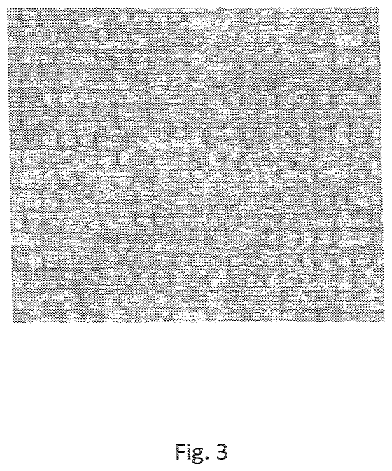

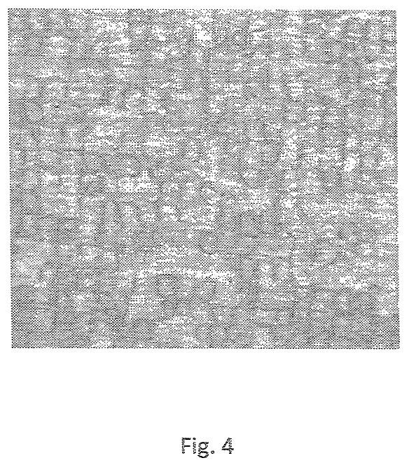

FIG. 3 illustrates an extremely close up optical image of the microstructure of annealed Nb C103 that has been printed using the additive manufacturing techniques taught herein. FIG. 4 illustrates the material of FIG. 3 after heating at 2900° F. for two hours. As may be seen in FIG. 4, the printed microstructure remains intact. In FIG. 4, there is no grain growth. The lack of grain growth means there is a stable microstructure and thus, stable mechanical properties.

The Nb C103 that has been printed with the methods taught herein has shown amazingly high temperature grain stability that is not naturally found in refractory alloys. In addition, testing has revealed that refractory alloys that are printed with the techniques taught herein show exceptional tensile strength at elevated temperature while remaining ductile.

As just one example of the better strength retention, at 2400° F., Nb C103 printed with the techniques taught herein with dispersoids, exhibited 1.8 times higher strength than the wrought counterpart.

In preferred embodiments, a process for additive manufacturing of an oxide and/or nitride enriched metal alloy powder, is provided. In preferred embodiments, the process comprises: (a) providing an oxide and/or nitride enriched metal alloy powder precursor or pretreated powder containing one or more metals oxides or nitrides; (b) depositing the powder into an inert atmosphere chamber provided in an additive manufacturing machine; (c) exposing the enriched metal alloy powder in the inert atmosphere chamber to a transient moving or stationary energy source for melting and solidifying a first layer, and, thereafter, repeating step (c) layer by layer in the well-known manner.

The oxide and/or nitrides added to the metal alloy powder generates dispersoids within the metal alloy when subjected to the transient energy source of the additive manufacturing process. The resulting metal alloy has a microstructure with oxide and nitride dispersoids.

In preferred embodiments, additional oxygen or nitrogen are added, or the levels available are maintained at a constant or elevated level, during the entire additive manufacturing process. Adding and/or maintaining higher levels of oxygen or nitrogen during the additive manufacturing process causes very stable oxides or nitrides to form in the material. These oxides and nitrides dispersoids form during the high temperature melting process where certain elements react to the oxygen and/or nitrogen to form the fine oxides and nitrides particles that rapidly solidify. These dispersoids are dispersed in the solid solution to provide the higher temperature stability and the extra strength in the material when it cools. The process forms in-situ oxides or nitrides and distributes them evenly/depreciatively throughout the solid solution matrix to stabilize materials at elevated temperatures and provide strength at temperature.

In preferred embodiments, the dispersoids have diameters in the range of 1 micron to 10 microns. In an even more preferred embodiment, the dispersoids have diameters in the range of 1 micron to 5 microns. In yet and even more preferred embodiment, the dispersoids have diameters in the range of 2 microns to 5 microns.

The elevated nitrogen or oxygen levels are preferably maintained during the entire additive manufacturing process. Adding nitrogen or oxygen during the additive manufacturing process is contrary to the normal thinking in the industry and the resulting strengthening that occurs is an unexpected result. Typically, the entire additive manufacturing process (printing process) is performed in an inert gas to protect the metal from coming in contact with and reacting with oxygen, or to lessor degree nitrogen. Alloys have strengthening elements such as titanium and aluminum which have a high affinity to oxygen. Once exposed to oxygen, oxides form and these oxides neutralize the effectiveness of the strengthening elements.

As noted above, in the embodiments taught herein, a higher volume or fraction of fine oxides is promoted (as long as they are stable oxides and are distributed evenly/discursively). These can act to pin the dislocation/grain boundary movement to prevent grain growth in size when exposed to high temperature and accordingly, result in a stronger material.

This invention also has implications for the manufacture of powders for use in the additive manufacturing process. Currently, the manufacture of powders for use with the additive manufacturing process is focused on, and struggling with, the reduction of oxygen content in the powders. With the new additive manufacturing processes disclosed herein, gas atomized powders with higher oxygen and/or nitrogen content can be used.

Currently, due to the reactivity of the refractory alloys, the standard process of gas atomization produced powders has 400 ppm-450 ppm oxygen or higher. The Aerospace Material Specification lists the requirements of oxygen and nitrogen for niobium alloy bars, rods and extrusions at 225 ppm maximum for oxygen and 150 ppm maximum for nitrogen. Accordingly, the powders are already out of specification and powder producers are constantly trying to reduce the oxygen and nitrogen contents.

The powder manufacturing process industry is struggling to reduce oxygen in the powders to meet the specification requirements. According to the present invention, of the additive manufacturing processes disclosed may increase oxygen/nitrogen in the powders to achieve our goal. In preferred embodiments, powders for use in the additive manufacturing process may have oxygen contents greater than 250 ppm. In yet other embodiments, the powders may have oxygen content in the range of between 500 ppm and 1000 ppm. In yet other embodiments, the powders may have an oxygen content of 500 ppm or greater. In yet other embodiments, the powders may have an oxygen content between 500 ppm and 3000 ppm. In yet other embodiments, the powders may have greater than 500 ppm of oxygen. In yet other embodiments, the powders may have between 1000 ppm and 2000 ppm of oxygen. In other embodiments, the powder may have from about 900 ppm to about 1100 ppm of oxygen. In yet other embodiments, the powders may have between 500 ppm and 1500 ppm of oxygen. In yet other embodiments, the oxygen content may be between 750 ppm and 1500 ppm. In still yet other embodiments, the oxygen content may be between 750 ppm and 2500 ppm.

In preferred embodiments, the nitrogen content in pretreated powder may be 50% of the oxygen levels disclosed above.

In preferred embodiments, powders for use in the additive manufacturing process may have a nitrogen content greater than 125 ppm. In yet other embodiments, the powders may have a nitrogen content in the range of between 250 ppm and 500 ppm. In yet other embodiments, the powders may have a nitrogen content of 250 ppm or greater. In yet other embodiments, the powders may have a nitrogen content between 250 ppm and 1500 ppm. In yet other embodiments, the powders may have a content of greater than 250 ppm of nitrogen. In yet other embodiments, the powders may have between 500 ppm and 1000 ppm nitrogen. In other embodiments, the powder may have between 450 ppm and 550 ppm of nitrogen. In yet other embodiments, the powders may have between 250 ppm and 750 ppm of nitrogen. In yet other embodiments, the nitrogen content may be between 375 ppm and 750 ppm. In still yet other embodiments, the nitrogen content may be between 375 ppm and 1250 ppm.

In preferred embodiments, between 0.05% to 0.2% oxygen, which is equivalent to about 500 ppm to 2000 ppm in the processing gas, i.e., the gas in the chamber, was used. Using 0.05% to 0.2% oxygen in the processing gas resulted in 700 ppm in the solid solution or higher. Maintaining this elevated level of oxygen during the entire additive manufacturing process has resulted in a stronger final material.

However, in other embodiments, other elevated levels of oxygen can be used including anything volumetrically greater than 0%. In some embodiments, between 0 and 0.2% is used. In other embodiments, between 0 and 1% oxygen may be used. In yet other embodiments, between 0.1% and 0.3% may be used. In still yet other embodiments, between 0.1% and 0.5% may be used. In still yet other embodiments between 0% and 3% may be used.

In preferred embodiments, the nitrogen content in the environmentally controlled portion of the additive manufacturing machine may be 50% of the oxygen levels disclosed above. In preferred embodiments, 0.025% to 0.1% nitrogen, which is 250 ppm to 1000 ppm in the processing gas, was used. Using 0.025% to 0.1% nitrogen in the processing gas resulted in 350 ppm in the sold solution or higher. Maintaining this elevated level of nitrogen during the entire additive manufacturing process has resulted in a stronger final material. However, in other embodiments, other elevated levels of nitrogen can be used including anything great that 0%. In some embodiments, between 0 and 0.1% is used. In other embodiments, between 0 and 0.5% nitrogen may be used. In yet other embodiments, between 0.05% and 0.15% may be used. In still yet other embodiments, between 0.05% and 0.25% may be used. In still yet other embodiments between 0% and 1.5% may be used.

In preferred embodiments, pretreatment of nominal metal powder under an oxygen and/or nitrogen environment above activation energy forms a layer of surface oxide or nitride. After pretreatment, the metal powders are exposed to either a transient energy source or stationary energy source for melting and solidifying in an inert atmosphere under an oxygen and/or nitrogen partial pressure environment.

According to some embodiments of the present invention, pretreatment of the metal powders includes partially pretreating a quantity powder to be processed by introducing the powder into a controlled atmosphere for additive manufacturing. The partial pretreatment, generally, comprises either exposing the quantity of the powder to be pretreated to the atmosphere and permitting it to be heated according to the ambient. Typically, depending on the amount of powder to be pretreated according to the partial pretreatment, the powder will generally contain from about 100 to about 1600 ppm of oxygen and/or nitrogen. Alternatively, the predetermined quantity can be preheated in controlled gas atmosphere having a controlled amount of oxygen and/or nitrogen added thereto. According to this external partial pretreatment, the powders are heated between 250° F. and 750° F. Even more preferably, the metal powders are heated between 400° F. and 600° F. and even more preferably, between 450° F. and 600° F. The application of heat to the powders as part of the pretreatment process accelerates oxidation.

In preferred embodiments, the additional heat is applied to the powder during the pretreatment stage for between 20 minutes and 120 minutes. Even more preferably, the heat is applied for between 40 minutes and 120 minutes. Ideally, the heat is applied for at least 60 minutes at a minimum.

In accordance herewith, the predetermined quantity of powder, having been previously, externally, partially pretreated, i.e., is then charged or introduced into a controlled inert atmosphere chamber, which is preferably the chamber in which the additive manufacturing is to be conducted, is further pretreated therein, thereby rendering a fully pretreated quantity of powder.

The fully pretreated charge is exposed to either a transient or stationary energy source for melting and solidifying the powder in an oxygen and/or nitrogen partial pressure environment, which is predominantly an inert gas.

The environment may be maintained with higher levels of oxygen of about 2000 ppm and minor amounts of nitrogen and/or nitrogen as taught herein. Among the useful inert gasses are argon, helium, neon, krypton and the like which are used in both the pretreatment and manufacturing stages. Preferably, helium is used.

Although the examples used herein are directed to Nb C103, any high temperature refractory metal and/or refractory metal alloy powders may be used without departing from the scope of the present inventions.

In another aspect hereof, the present invention provides for the introduction of Hafnium Oxide and Hafnium Carbide dispersoids which are extremely stable compounds. The introduction of these dispersoids can be provided inexpensively by introducing carbon into the alloy powder or by introducing Carbon Dioxide (CO2) in an LPBF chamber. The hafnium's extreme high reactivity with both carbon and oxygen is very reliable and its strengthening effectiveness provides a reduction of the Hafnium content in the alloys as solid strengthening components and substitutes with the strengthening of Hafnium dispersoids, i.e. the combination of ODS and CDS materials. Generally, from about 0.5% to about 2% by volume of carbon dioxide is introduced into the chamber during the additive manufacturing process. The resulting Hf C dispersoids are evenly distributed throughout the object and are of the same size as the oxide and/or nitride dispersoids.

1. A method of fabricating an object using additive manufacturing comprising:
(a) providing a quantity of refractory alloy powder from the group consisting of niobium alloy powder, rhenium alloy powder, tantalum refractory alloy powder, molybdenum refractory alloy powder and tungsten refractory alloy powder;
(b) partially pretreating the powder by exposing it to either the ambient or in a controlled inert atmosphere and introducing oxygen and/or nitrogen thereinto for a period of about 20 to about 120 minutes;
(c) depositing the partially pretreated quantity of refractory powder into an environmentally controlled inert gas chamber;
(d) introducing oxygen or nitrogen into the chamber to create a partial pressure atmosphere in the chamber to further pretreat the quantity to provide a fully pretreated charge of powder;
(e) exposing the powder in the chamber to either a transient or stationary energy source to melt and solidify the powder to create a first layer;
(f) repeating step (e) until the object is fabricated; and wherein
(g) dispersoids are formed in situ in the layers with the dispersoids having diameters of between 1 micron and 10 microns.

2. The method of claim 1 further comprising: adjusting the environmentally controlled chamber to have between 250 ppm and 1000 ppm nitrogen.

3. The method of claim 1 further comprising adjusting the oxygen content of the environmentally controlled atmosphere to be between 500 ppm and 2000 ppm.

4. The method of claim 1, wherein the refractory alloy powder is niobium refractory alloy powder.

5. The method of claim 1, wherein the refractory alloy powder is tungsten refractory alloy powder.

6. The method of claim 1, wherein the refractory allow powder is rhenium refractory alloy powder.

7. The method of claim 1, wherein the refractory allow powder is tantalum refractory alloy powder.

8. The method of claim 1, wherein the refractory allow powder is molybdenum refractory alloy powder.

9. The method of claim 1, wherein the oxygen content is between 750 ppm and 1500 ppm.

10. The method of claim 1 which further comprises repeating steps (c) through (f) sequentially until the object is fabricated.

11. The method of claim 1, wherein the niobium refractory alloy powder is Nb C−103.

12. The method of claim 1, wherein the energy source is a transient energy source.

13. The method of claim 1, wherein the energy source is a stationary energy source.

14. The method of claim 1, wherein the energy source is a laser beam.

15. An additive manufacturing fabricated object comprising:
a high temperature refractory alloy object having dispersoids distributed throughout the object.

16. The object of claim 15 wherein the dispersoids have a diameter of between 1 micron and 10 microns.

17. The object of claim 16 wherein the dispersoids consist essentially of an oxide, a nitride and mixtures thereof.

18. The object of claim 15 wherein the dispersoids are oxide dispersoids.

19. The object of claim 15 wherein the dispersoids are nitride dispersoids.

20. The object of claim 15 wherein the refractory alloy is selected from the group consisting essentially of a niobium alloy, rhenium alloy, tantalum alloy, molybdenum alloy and tungsten alloy.

21. The object of claim 20 wherein the refractory alloy is niobium C103.

22. A high temperature refractory metal alloy powder for use in additive manufacturing consisting essentially of a niobium alloy, rhenium alloy, tantalum alloy, molybdenum alloy and tungsten alloy, having an impurity level of between about 250 to about 3,000 ppm or a nitrogen content of between about 125 ppm and 1,250 ppm.

23. A high temperature refractory metal alloy powder for use in additive manufacturing consisting essentially of hafnium alloy having hafnium carbide dispersoids distributed throughout the object.
